(19) United States
(12) Patent Application Publication
(10) Pub. No.: US 2007/0231517 A1
(43) Pub. Date: Oct. 4, 2007

(54) METHOD OF REDUCING THE TENDENCY FOR WATER INSOLUBLE FILMS TO FORM ON THE EXPOSED SURFACES OF CONTAINERS AND ARTICLES WHICH ARE USED TO CONTAIN WATER BORNE COATINGS AND ARTICLE

(76) Inventor: ROBERT F. GOLOWNIA, Hudson, OH (US)

Correspondence Address: THE GLIDDEN COMPANY, 15885 WEST SPRAGUE ROAD, STRONGVILLE, OH, 44136, US

(21) Appl. No.: 11/695,386

(22) Filed: Apr. 2, 2007

Related U.S. Application Data
(60) Provisional application No. 60/787,835, filed on Mar. 31, 2006.

(51) Int. Cl. B05D 5/00; B32B 27/08

(52) U.S. Cl. 428/35.7; 427/256

(57) ABSTRACT

The present disclosure describes a method of inhibiting film or skin formation on exposed interior surfaces of containers of waterborne coating products without substantial contribution to volatile organic content of the coating composition, and describes the article with the coating composition having a reduced tendency for film or skin formation. The method involves applying to the coating composition in the container an aqueous mixture, comprising at least one surfactant with oxyalkylene moieties wherein the surfactant is essentially non-volatile and present in about up to 60 weight percent of the mixture. The article is a lidded container having the coating composition with a float on the composition's surface that is closest to the headspace within the container.

This application claims the benefit including that of priority under 35 U.S.C. 119(e) of U.S. Provisional Patent Application Ser. No. 60/787,835, filed Mar. 31, 2006, entitled “Method of Reducing the Tendency for Formation of Water Insoluble Film on Water Borne Coatings in Containers and Article,” the complete disclosure of which is hereby incorporated by reference.

### FIELD OF THE DISCLOSURE

The present disclosure is directed to aqueous mixtures containing one or more liquid organic materials as a float which performs in a manner to reduce the tendency for formation of non-water-dispersible films on the exposed interior surface(s) of containers and lids containing water borne coatings.

### INTRODUCTION TO THE DISCLOSURE

Waterborne coating products such as latex paints and water based stains are prone to develop water insoluble films, commonly known as “skins”, on the non-submerged, or exposed, interior surfaces of the plastic or metal containers and lids that are used to store and transport paint products before use.

The use of mixtures of water and relatively volatile glycols to inhibit skin formation is taught by U.S. Pat. No. 4,228,893 that discloses inhibiting paint product skins by placing mixtures “whose volatility is at least substantially equivalent to the volatility of the volatile portion of the paint composition” onto the surface of the liquid paint. U.S. Pat. No. 4,228,893 further teaches that the quantity of skin inhibiting mixture to be used “provides a layer of barrier material from about one inch to about three inches thick”.

U.S. Pat. No. 6,354,063 teaches the use of mixtures of water and low volatility glycols which are effective at inhibiting skin formation. However such glycols still contribute somewhat to the Volatile Organic Compound content (VOC-content) of the coating compositions to which the skin inhibiting mixture has been applied when the mixture is subsequently incorporated into the paint by the shaking or stirring normally carried out prior to use of the coating.

Air pollution regulations of various governmental units or agencies as exemplified by the following list of rules requires that paints and coatings emit increasingly limited amounts of volatile organic compounds (VOCs) to the atmosphere. National Rule: 40 CFR, Part 59, Subpart D—National Volatile Organic Compound Emission Standards for Architectural Coatings; South Coast AQMD: RULE 1113. Architectural Coatings; San Diego APCD: RULE 67.0. Architectural Coatings; Bay Area AQMD: REGULATION 8 Organic Compounds RULE 3 Architectural Coatings; Butte County AQMD: RULE 230 Architectural Coatings; Colusa County APCD: RULE 2.26 Architectural Coatings; El Dorado County APCD: RULE 215 Architectural Coatings; Feather River AQMD: RULE 3.15 Architectural Coatings; Imperial County APCD: RULE 424 Architectural Coatings; Kern County APCD: RULE 410.1 Architectural Coatings; Monterey Bay APCD: RULE 426 Architectural Coatings; Mojave Desert AQMD: RULE 1113 Architectural Coatings; Northern Sonoma County APCD: RULE 485 Architectural Coatings; Placer County APCD: RULE 218 Architectural Coatings; Santa Barbara County APCD: RULE 323 Architectural Coatings; Shasta County AQMD:RULE 3:31 Architectural Coatings; San Joaquin Valley APCD: RULE 4601 Architectural Coatings; San Luis Obispo County APCD: RULE 433 Architectural Coatings; Sacramento Metropolitan AQMD: RULE 442 Architectural Coatings; Tehama County APCD:RULE 4:39 Architectural Coatings; Ventura County APCD: RULE 74.2 Architectural Coatings; Yolo-Solano AQMD: RULE 2.14 Architectural Coatings; State of Maine CHAPTER 151: Architectural and Industrial Maintenance (AIM) Coatings; State of Delaware REGULATION NO. 41 Limiting Emissions of Volatile Organic Compounds from Consumer and Commercial Products, Section 1—Architectural and Industrial Maintenance Coatings; State of Maryland Title 26 Department of the Environment Subtitle 11 Air Quality, Chapter 33 Architectural Coatings; State of New Jersey TITLE 7, Chapter 27 Subchapter 23 Prevention of Air Pollution from Architectural Coatings; State of New York Chapter III, Subpart A, Part 205 Architectural and Industrial Maintenance (AIM) Coatings; State of Pennsylvania Subchapter C. Section 130.600 Architectural and Industrial Maintenance Coatings; and State of Virginia 9 VAC 5 CHAPTER 40. Existing Stationary Sources, PART II. Emission Standards, ARTICLE 49. Emission Standards for Architectural and Industrial Maintenance Coatings in the Northern Virginia Volatile Organic Compound Emissions Control Area (Rule 4-49) and the like.

Although the glycol-based skin inhibiting materials disclosed in the aforementioned patent are useful for inhibiting skin on exposed interior surfaces of the coating container, further improvement of skin inhibiting materials is desired in order to reduce their contribution to Volatile Organic Compounds (VOCs). Such a reduction in contribution concomitantly would result in a reduction to the emission of VOCs to the atmosphere.

### SUMMARY OF THE DISCLOSURE

Although the present disclosure may fulfill one or more of the above-mentioned needs, it should be understood that some aspects of the invention might not necessarily obviate one or more of those needs. In the following description, certain aspects and embodiments will become evident. It should be understood that the invention, in its broadest sense, could be practiced without having one or more features of these aspects and embodiments. It should be understood that these aspects and embodiments are merely exemplary.

The method and article of manufacture described in this disclosure rely on the use of a relatively small amount of a mixture that comprises water and at least one non-ionic or anionic surfactant which is added to the container after the water borne coating composition, such as a paint product, has been placed in the container. The container lid is then sealed, leaving behind a small headspace within the container that contains mostly air. The amount of headspace may vary with container types (e.g., plastic containers containing internal devices such as roller trays or grids require a larger headspace), as well as formula types (e.g., deep tint-base formulas require more headspace because of the need to add larger volumes of colorants or tinters prior to end use). The present disclosure specifically utilizes paint skin-inhibiting aqueous mixtures that contain at least one poly (oxyalkylene) polymer or copolymer that is a non-ionic or anionic surfactant that is essentially free of organic volatiles (“essentially non-volatile”) or put another way substantially nonvolatile both as determined by ASTM Method D 6886-03 (Standard Test Method for Speciation of the Volatile Organic Compounds (VOCs) in Low VOC Content Waterborne Air-Dry Coatings by Gas Cliromatograph).

The skin inhibiting materials of the present disclosure are essentially nonvolatile thereby drastically limiting their contribution to the VOC-content of the coating product(s), most all of which are ultimately released into the atmosphere. Further, the skin inhibiting materials of the present disclosure are eventually mixed into the water borne coating in a manner such that they do not interfere with the overall performance aspects of the coating.

In one embodiment of the present disclosure a method involves applying an aqueous mixture comprising at least one non-ionic or anionic surfactant with oxyalkylene moieties in an amount up to around 60 weight percent of the mixture to a water borne coating composition. The application of the mixture to the coating composition is to provide a float on the coating composition which is held in a container as opposed to mixing the aqueous mixture into the coating composition or paint. The essentially nonvolatile non-ionic or anionic surfactant is used as the active component of the aqueous mixture for skin inhibiting (“antiskin”). In one embodiment of the disclosure suitable surfactants are polymeric surfactants such as polyoxypropylene-polyoxyethylene copolymers a suitable version of which is ethylene oxide-propylene oxide-ethylene oxide (EO-PO-EO) copolymer non-ionic surfactant, where EO=ethylene oxide; PO=propylene oxide. These materials unlike non-polymeric glycol float materials are essentially non-volatile in nature so they do not contribute in any significant way to the VOC-content of the water borne coating. It is believed without limiting the scope of the invention that this type of surfactant in the antiskin mixture is effective because of two (2) primary characteristics. One is the adequate resistance of the antiskin mixture to mixing to form a float with the bulk coating composition during transportation and storage. Another characteristic is the ability of the antiskin mixture to form pasty mixtures with the coating composition, and this provides a degree of resistance to drying and allows for redispersiblity of the pasty mixture in the bulk coating composition even when water is removed by evaporation from the coating composition.

### BRIEF DESCRIPTION OF THE DRAWINGS

FIG. 1 represents a bar graph which depicts the results of a trial transportation test (Ohio to Texas and return to Ohio) which was conducted on a number of different float materials (depicted on the x-axis) that were added on the exposed surface of a water borne coating composition in the containers whereby the average skin weights that formed on the lids of 5-gallon plastic pails (depicted on the y-axis) were determined.

### DETAILED DESCRIPTION OF THE DISCLOSURE

The present disclosure relates to a film forming coating composition and in one embodiment to a paint composition, however, alternative embodiments include, without limitation, those of water borne stains and varnishes. Non-exclusive examples of coating compositions that can be used are those disclosed in U.S. Pat. No. 6,354,063. Useful coating compositions are, for example, water borne or latex type coating compositions as for instance latex paints, including any of those known to those skilled in the art.

Also the antiskin aqueous mixture of the present disclosure can form a float on the coating composition in containers in a manner similar to the use of mixtures of water and the mixture of non-polymeric glycol and water of U.S. Pat. No. 6,354,063 which is incorporated herein by reference. Although the glycols of U.S. Pat. No. 6,354,063 are very effective at inhibiting the formation water insoluble films (commonly referred to as skins or paint skins, etc.) on the non-submerged or exposed interior portions of the container or article holding the coating composition, the glycols exhibit a degree of volatility that contributes to the Volatile Organic Compound content (VOC-content) of the coating composition. With industry and governmental regulations striving for additional reductions in VOCs for coating compositions, whether formulated for interior or exterior application, replacing such glycol-containing floats can offer significant VOC reductions.

As used in the afore-discussed embodiments and other embodiments of the invention described herein the following terms generally have the meaning as indicated to assist in an understanding of the disclosure but not to limit the scope of the invention if the benefit of the invention is achieved by inferring a broader meaning to the following terms.

The term “float” generally refers to a layer of specialized material that is applied to the exposed surface of a liquid water borne coating composition in a container (so as to minimize the extent of mixing therein) and then remains floating on the surface of the water borne coating composition during periods of subsequent transportation and storage, hence the terminology “float”. As noted in U.S. Pat. No. 6,354,063 the present disclosure uses at least one layer of “float material” or “barrier material” (skin inhibiting mixture) that is less than one inch in thickness (more suitably less than about 0.25 inch). Also on vigorous mixing to the degree to incorporate a colorant or tint into the coating composition the float also mixes into the coating composition.

The term “water-dispersible” generally refers to a polymeric film that is itself capable of being dispersed into available water of water based or water borne coating compositions (i.e., without requiring the use of a separate surfactant) so that the film is undetectable to the unaided human eye when the coating is applied as a wet film to a substrate.

The term “waterborne coating composition” is understood to mean conventional water-borne coating compositions, materials, and formulations that have no compressed fluid admixed therewith. Such coating compositions are generally comprised of a nonvolatile materials fraction comprising at least one polymer component that is capable of forming a coating film on a substrate, whether such component is a paint, enamel, lacquer, varnish, adhesive, chemical agent, release agent, lubricant, protective oil, an agricultural coating, or the like. The water-borne coating compositions, in addition to the nonvolatile materials fraction, also contain a solvent fraction which is typically at least partially miscible with the nonvolatile materials fraction. As used herein, it will be understood that the term “water borne coating composition” includes not only coating compositions used to form protective or decorative coatings but can also include adhesives, release agents, lubricants, agricultural materials, and the like, which are capable of being sprayed, brushed, rolled, or the like to deposit a coating on a substrate. In other words these can be coating compositions in which the polymeric binder is a dispersion of insoluble polymer in water. Waterborne paints can be referred to as “emulsion paints” and these represent the most common type of wall and ceiling paints now in use. Emulsion paints were first developed in the late-1940's/early-1950's. Also waterborne coatings can be predominantly liquid and generally can be prepared from liquid blended raw materials, such as titanium dioxide slurries, extender pigment slurries, thickener slurries, glycol slurries, and latex binders. The liquid blends have substantially the same viscosity characteristics as the final waterborne coating composition, in the range of about 70-125 Krebs units. Emulsion paints comprise a film-forming polymer which is insoluble in water and which is in the form of a colloidal dispersion (sometimes called an “emulsion” or “latex”). They also comprise one or more particulate non-film forming solids which can be pigments, such as titanium dioxide, or extenders such as powdered chalk. The paints usually also comprise a thickener. So the terms “aqueous borne” and “water borne coatings” have their art-recognized meaning which allows for the inclusion of minor amounts of co-solvents and other volatile organic materials provided water constitutes more than around 50%, and more suitably at least 80% of the volatile phase so that even with the presence of organic solvents these coatings are still regarded as water borne since the majority of the volatile solvent present in the liquid coating composition is water.

The term “latex” for a coating composition means the primary film forming polymeric components of the composition or paint are those that are capable of being dispersed in water by themselves or through the use of secondary emulsifying agent (e.g., a surfactant) for creating an emulsion of polymer particles in water.

The term “latex paint” refers to those water borne paints which are characterized in that a resinous binder is solubilized, dispersed or emulsified in an aqueous phase, commonly referred to as the continuous phase which is predominantly water. Suitable water borne binding agents can generally include materials such as starch, modified starch, polyvinyl alcohol, polyvinyl acetate, polyethylene/acrylic acid copolymer, acrylic acid polymers, polyacrylate, polyacrylamide copolymers, acrylonitrile/butadiene/styrene copolymers and polyacrylonitrile and compatible combinations of any two or more of these.

The word “pigment” is of Latin origin (pigmentum) and originally denoted a color in the sense of a coloring matter, but was later extended to indicate colored decoration (e.g., makeup). The modern meaning associated with the word pigment means a substance composed of small particles that is practically insoluble in the applied medium and is used on account of its coloring, protective, or magnetic properties. Both pigments and dyes are included in the general term “coloring materials”, which denotes all materials used for their coloring properties. The characteristic that distinguishes pigments from soluble organic dyes is their low solubility in solvents and binders. Pigments can be characterized by their chemical composition, and by their optical or technical properties. In the Color Index (C.I.) pigments are usually named “C.I. Pigment XY xy”. Some compounds may be named “C.I. Solvent XY xy” due to their migration tendency in polymer application, although in water or organic solvents these compounds may fulfill the insolubility criteria for pigments. Pigments can be classified into two general categories of: (i) inorganic pigments, and (ii) organic pigments.

Also herein, “a,” “an,” “the,” “at least one,” and “one or more” are used interchangeably.

Also herein, the recitations of numerical ranges by endpoints include all numbers subsumed within that range (e.g., 1 to 5 includes 1, 1.5, 2, 2.75, 3, 3.80, 4, 5, etc.).

Also herein, the terms “comprises” and variations thereof do not have a limiting meaning where these terms appear in the description and claims.

All percentages, ratios and proportions herein are by weight, unless otherwise specified. All temperatures are in degrees Celsius (° C.) unless otherwise specified. All documents cited are incorporated herein by reference in their entireties. Citation of any reference is not an admission regarding any determination as to its availability as prior art to the claimed invention.

Other than in the operating examples, or where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches. Notwithstanding that the numerical ranges and parameters setting forth the broad scope of the invention are approximations, the numerical values set forth in the specific example are reported as precisely as possible. Any numerical value, however, inherently contains certain errors necessarily resulting from the standard deviation found in their respective testing measurements. As a whole, all values mentioned are indicated in conformity with the international legislation on the one hand, and in amounts pertaining to the mass on another hand. Unless otherwise stated, the proportions of the components in the compositions described are given in percentage pertaining to the total mass of the mixture of these components.

The antiskin mixture of the present disclosure has at least water and one or more or a combination of materials that have at least an ability to resist incorporation into the coating composition by weaker mixing actions like those experienced by the bulk coating composition during the periods of subsequent transportation and/or storage. Also, if any incipient skin formation occurs from the coating composition the antiskin mixture should have the ability to form mixtures with any coating composition which has splashed onto the lid or non-submerged container walls like pasty mixtures with the coating so that any incipient skin formation resists drying and is redispersible in the bulk coating composition even when water has been removed from the pasty mixture by evaporation (it's “redispersibility”). Other considerations also include, without limitation, the antiskin mixture's ability to act as a barrier to formation of water insoluble films or skins, it's ability to be mixed into the water borne coating composition at least with mixing as vigorous as that for incorporating colorant or tint into the coating composition. Also, the antiskin mixture should have the ability to provide such performance in a manner which does not adversely impact the overall general performance of the water borne coating composition. Also, the antiskin mixture of the present disclosure has the ability to accomplish these tasks while at the same time not adversely affecting the overall VOC-content of the water borne coating (e.g., being essentially non-volatile). Non-exclusive examples of suitable non-ionic and anionic surfactants for the float mixture include, Poly (oxy-1,2-ethanediyl), α-(nonylphenyl)-ω-hydroxy as commercially available under the trade name Tergitol NP 7 from Union Carbide, Houston, Tex., Sorbitan, monododecanoate, poly(oxy-1,2-ethanediyl) as commercially available under the trade name Tween 20 from Cayman Chemical Company, Ann Arbor, Mich., Poly (oxy-1,2-ethanediyl), α-(nonylphenyl)-ω-hydroxyl- as commercially available under the trade name Tergitol NP 8 from Union Carbide, Houston, Tex., Polyoxypropylene-polyoxyethylene Block Copolymer (mol. weight 2,650 g/mol, 60% PO, 40% EO as commercially available under the trade name Pluronic 17R4 from BASF, Mount Olive, N.J. 07828-1234), Polyoxypropylene-polyoxyethylene Block Copolymer (mol. weight 1,100 g/mol, 90% PO, 10% EO as commercially available under the trade name Pluronic L31 from BASF, Mount Olive, N.J. 07828-1234), Polyoxypropylene-polyoxyethylene Block Copolymer (mol. weight 1,900 g/mol, 50% PO, 50% EO as commercially available under the trade name Pluronic L35 from BASF, Mount Olive, N.J. 07828-1234), Polyoxypropylene-polyoxyethylene Block Copolymer (mol. weight 1,850 g/mol, 70% PO, 30% EO as commercially available under the trade name Pluronic L43 from BASF, Mount Olive, N.J. 07828-1234), Polyoxypropylene-polyoxyethylene Block Copolymer (mol. weight 2,200 g/mol, 60% PO, 40% EO as commercially available under the trade name Pluronic L44 from BASF, Mount Olive, N.J. 07828-1234), Polyoxypropylene-polyoxyethylene Block Copolymer (mol. weight 2,500 g/mol, 80% PO, 20% EO as commercially available under the trade name Pluronic L62 from BASF, Mount Olive, N.J. 07828-1234), Polyoxypropylene-polyoxyethylene Block Copolymer (mol. weight 2,900 g/mol, 60% PO, 40% EO as commercially available under the trade name Pluronic L64 from BASF, Mount Olive, N.J. 07828-1234), Polyoxypropylene-polyoxyethylene Block Copolymer (mol. weight 2,750 g/mol, 90% PO, 10% EO as commercially available under the trade name Pluronic L81 from BASF, Mount Olive, N.J. 07828-1234), Polyoxypropylene-polyoxyethylene Block Copolymer (mol. weight 3,400 g/mol, 50% PO, 50% EO as commercially available under the trade name Pluronic P65 from BASF, Mount Olive, N.J. 07828-1234), Polyoxypropylene-polyoxyethylene Block Copolymer (mol. weight 4,200 g/mol, 60% PO, 40% EO as commercially available under the trade name Pluronic P84 from BASF, Mount Olive, N.J. 07828-1234). These materials can be used alone or in any chemically and physically stable combination of two or more of them in at least water to form the antiskin mixture. Of the afore-mentioned non-ionic surfactants, when used alone, the oxyalkylene type moieties should have between 5 to 50 weight percent ethylene oxide (EO).

The components of the antiskin mixture are mixed together by adding the float material, i.e, non-ionic or anionic surfactant, to the appropriate amount of deionized water in order to obtain the desired percent solution. The solutions can be stirrer or mixed by any method known to those skilled in the art and suitably in a manner not to produce large quantities of foam. The mixing is usually continued until the mixtures are clear. The amounts of surfactant and water in the mixture can range from greater than 0% to 60% by weight, more suitably from 1% to less than 20% by weight, and even more suitably form 1% to 15% by weight. A most suitable amount of the surfactant that is a poly(oxyethylene) oxypropylene block copolymer with an hydroxyl terminating group on one end and a hydrogen on the other end appears to be around 6% by weight. A doubling of the amount of this non-ionic surfactant did not provide a concomitant improvement in the redispersibility of the incipient skins. Therefore, the adding of additional surfactants, even though it did result in lesser amounts of incipient skin formation, added additional costs and slightly higher VOC impacts for only slightly improved overall performance. It should also be noted that some of the test materials created a thickened water solution, but the float mixtures were still suitable for their intended purpose. In most instances, the thickened water solutions occurred relative to the higher surfactant/water ratios.

In one embodiment of the present disclosure suitable coating composition is a paint comprising a vehicle, acting as the continuous phase, and a pigment, acting as a discontinuous phase. The vehicle comprises a polymer and/or resin binder. In most cases the vehicle comprises a diluent such as water (in the case of emulsions). The pigment may include additives, primary pigment and/or extenders. For instance, latex paints for the consumer market can be based on polymeric binders prepared by emulsion polymerization of ethylenic monomers.

A typical consumer latex paint binder may contain a vinyl acetate copolymer consisting of polymerized vinyl acetate (80%) and butyl acrylate (20%) or other vinyl or acrylic copolymer binders that can form films. The hardness of the latex polymer must be balanced to permit air drying and film formation at ambient temperatures, which requires soft polymer units. At the same time the polymer must be hard enough in the final dry film to provide resistance properties, which requires hard polymer units.

Further non-exclusive examples of polymer and/or resin binder in latex paints that can be used as film formers or binders can be vinyl copolymer binders containing at least 40% and preferably between about 80% to 100% of copolymerized vinyl unsaturated monomers containing vinyl double bond unsaturation including, for example, vinyl esters such as vinyl acetate, vinyl propionate, vinyl butyrates, vinyl benzoate, isopropenyl acetate and like vinyl esters; vinyl amides, such as acrylamide and methacrylamide; and vinyl halides such as vinyl chloride. Ethylenically unsaturated monomers other than said vinyl unsaturated monomers can include, for example, those monomeric materials exhibiting ethylenic double bond unsaturation such as polymerizable allylic, acrylic, fumaric, maleic, or like ethylenically unsaturated double bond functionality (carbon-to-carbon unsaturation) which can be copolymerized with the vinyl double bond in said vinyl unsaturated monomers. Ethylenically unsaturated monomers other than vinyl unsaturated monomers can include, for example, styrene, methyl styrenes, and similar alkyl styrenes, chlorostyrene, vinyl toluene, vinyl naphthalene, divinyl benzene, diallyl phthalate and similar diallyl derivatives, butadiene, alkyl esters of acrylic and methacrylic acid and similar ethylenically unsaturated monomers. Other suitable binders based on acrylic copolymers including copolymerized low alkyl esters of acrylic or methacrylic acid having an alkyl ester portion containing between 1 to 12 carbon atoms as well as aromatic derivatives of acrylic and methacrylic acid. Useful acrylic monomers include, for example, acrylic and methacrylic acid, methyl acrylate and methacrylate, ethyl acrylate and methacrylate butyl acrylate and methacrylate, propyl acrylate and methacrylate, 2-ethyl hexyl acrylate and methacrylate, cyclohexyl acrylate and methacrylate, decyl acrylate and methacrylate, isodecylacrylate and methacrylate, benzyl acrylate and methacrylate, and various reaction products such as butyl, phenyl, and cresyl glycidyl ethers reacted with acrylic and methacrylic acids, hydroxyl alkyl acrylates and methacrylates such as hydroxyethyl and hydroxypropyl acrylates and methacrylates, as well as amine acrylates and methacrylates. Also the ethylenically unsaturated monomers can be copolymerized by free radical induced addition polymerization using peroxy or azo catalysts, common redox catalysts, ultraviolet radiation, or the like. Latex paints ordinarily contain opacifying pigments, tinctorial pigments for imparting color, and non-opacifying filler or extender pigments. Latex points film are formed by coalescence of the film forming binder polymer particles at ambient temperatures to form a binding matrix and a hard tack-free paint film. Particularly desirable coalescing solvents are phenyl ether of diethylene glycol, diethylene glycol butyl ether, and dibutyl phthalate, diethylene glycol monobutyl ether acetate or monoethyl ether acetate, and 2,2,4-trimethyl-1,1,3, pentanediol monoisobutyrate.

Generally the latex polymer, binder or film former can have from about 30 to about 75% solids and a mean latex particle size of from 70 to 650 nm. The latex polymer is suitably present in the aqueous coating composition in an amount from 5 to 60 percent by weight, and more suitably from 8 to 40 percent by weight (i.e. the weight percentage of the dry latex polymer based on the total weight of the coating composition). When more than one latex polymer is present for instance

a film former or binder that is a vinyl acrylic and a styrene acrylic latex mixtures one latex can be present in an amount of at least about 1% by weight of the total paint formulation, more suitably at least about 3% by weight and most suitably at least about 6% by weight of the total paint formulation while the other latex or lattices are present to make up the total amount of latex present in the coating composition.

A suitable diluent that can be present can have some or all water. The diluent is either an emulsion of a solvent and water, or a 100% water emulsion. More preferably, the diluent is water, which is used to emulsify the polymer and/or resin binder.

The amount of primary and extender pigment used in the paint of the present invention is determined by the pigments intensity and tinctorial strength, the required opacity, the required gloss, and/or the resistance and durability desired. Pigments used in the present invention can be inorganic, organic or combinations thereof. Examples of primary pigments include but are not limited to titanium dioxide, lead oxide, zinc oxide, zinc sulfide, lithopone, antimony oxide, carbon black, graphite, black iron oxide, micaceous iron oxide, iron oxide, metal complexes, benzimidazolone, azo condensation, lead chromate, cadmium yellow, yellow oxides, mixed phase metal oxides, bismuth vanadate, arylamide, diarylide, benzimidazolone, disazo condensation, organic metal complexes, isoindolinone, isoindoline, quinophthalone, anthrapyrimidine, flavanthrone, pyrazolone orange, perinone orange, lead molybdate, cadmium red, red iron oxide, β-naphthol, BON arylamides, benzimidazolone, quinacridone, perylene, anthraquinone, dibromanthrone, pyranthrone, diketopyrrolo-pyrrole, prussian blue, ultramarine, cobalt blue, copper and copper free phthalocyanine, indanthrone, chrome green, chromium oxide, hydrated chromium oxide, halogenated copper phthalocyanine, metal flake, pearlescent pigments and the like and combinations thereof.

Extender pigments are used to extend the more expensive white and colored pigments to reduce the cost and impart certain performance characteristics to the paint. The use of extender pigments may affect the flow properties, the stability to sedimentation and the film strength. Most extenders are off-white to white in color and have a refractive index close to that of commonly used binders. Therefore, unlike titanium dioxide they give relatively little opacifying effect. Examples of extenders include but are not limited to calcium carbonate, aluminum silicate, magnesium silicate, barium sulfate, silica, and the like and combinations thereof.

Also, the paint can further comprise a humectant. Examples of humectants include but are not limited to propylene glycol, ethylene glycol, polyethylene glycol, glycerol, sucrose and combinations thereof. While the humectant is not necessary for the present invention, the humectant has the unexpected ability to lengthen the time required for the paint to change colors upon drying.

Additives to paints are generally added at low levels but nevertheless have a marked effect on the properties of the paint. Examples of types of additives that are added to the paint of the present invention include but are not limited to anti-corrosive pigment enhancers, emulsifiers, surfactants, dispersants, curing agents, coalescents, wetting agents, biocides, thickeners, rheology modifiers, plasticizers, waxes, anti-oxidants, antifoaming agents, antisettling agents, corrosion inhibitors, dispersion aids, antistatic additives, flash corrosion inhibitors, floating and flooding additives, in-can and in-film preservatives, insecticidal additives, optical whiteners, ultraviolet absorbers, and the like and any combinations of two or more of these.

To this composition present in a container for transporting and selling the composition, the antiskin float mixture is added in a manner so that it rests on the surface of the liquid coating composition that is inside of the container. The film thickness of the float material is generally less than about 0.25 inches, and can be a minimum of just a continuous film across the surface of the liquid coating composition. An “effective amount” to form such a continuous film layer would most suitably be between about 0.03 to 0.25 inches, depending in part upon the actual viscosity of the float material itself. The container can be a plastic or metal container which is open at one end to allow for filling of the container with the coating composition and to allow for removal of the coating from the container to apply the coating to a surface to form a dried film. Also, such a container can have a head space that may vary in volume depending upon the type of container. For instance, with traditional metal paint containers the head space above the paint is a minimum to allow for addition of a colorant or tint for mixing in paints other than ready-mix paints. Of course, the antiskin float mixture can also be used with ready-mix paints. The head space in some plastic containers can be of a volume to accommodate the presence of paint application devices like grids, trays or shelves to assist in application of the paint to an applicator like a roller or brush or sprayer.

Skinning of latex-based water borne coating products such as paint in closed containers has been a puzzling phenomenon known in the coatings industry for many years. One non-limiting hypothesis to explain latex paint skinning is that it is a drying process that results when moisture escapes from the closed container by permeating through the container walls and/or by escaping from leaks caused by insufficient sealing of the lid to the container body. It has been found that latex paint skinning is indeed likely to be a drying process but that it is caused by the transfer of moisture from liquid paint adhering to the lid and/or non-submerged walls of the container to the bulk paint by differences in the temperature between paint on the lid and container walls and bulk paint. Such temperature differences are the result of normal fluctuations in the ambient temperature at which the container of paint is transported and/or stored. A non-limiting explanation is that because the thermal heat capacity of the paint/lid combination of the container is less than the heat capacity of the bulk paint/container combination, temperature differences will occur as the ambient temperature changes. For example, over the course of a night in a moderate climate, an entire five gallon container of paint could cool to about 60 degrees Fahrenheit. As the morning arrives, ambient temperatures increase and the lid and its' adhering paint will begin to warm while the bulk paint remains relatively cool because of its' higher net heat capacity. Measurements made using thermocouples attached to a five gallon pail of ordinary latex wall paint showed that during the daytime hours, paint adhering to the underside of the lid reached and maintained temperatures 15 to 20 degrees F. warmer than bulk paint after being stored outside the previous night.

### EXAMPLES

### Example 1

The present disclosure is illustrated in more detail by the non-limiting examples described below.

Several aqueous mixtures of antiskin float materials were prepared. The experimental floats were mixed by adding the float material to the appropriate amount of deionized water in order to obtain the desired percent solution (water with no float material, 6% by weight aqueous solution, 8% by weight aqueous solution, 10% by weight aqueous solution, 12% by weight aqueous solution). The solutions were stirred with the necessary size mixing blade for the quantity of float material solution being prepared, powered by an air motor at a speed conducive to dissolving the surfactant float materials without creating a large quantity of foam. Mixing of the aqueous float materials continued until a clear, homogenous mixture was obtained.

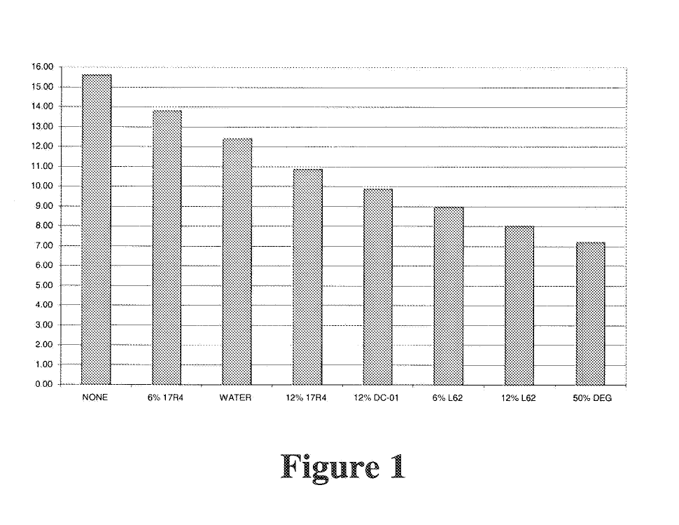

Paints with either Pluronic L62, Pluronic 17R4 or the Carbowet DCOI were tested as float additions as shown in the bar graph of FIG. 1 and tables below summarizing these in comparison to employing the water and glycol float of (DEG/Water, 50/50 like that of U.S. Pat. No. 6,354,063). Entire pallets of low-VOC water borne paint from ICI Paints had the paint containers “floated” with the prototype formulas. These pallets were trucked from a location in Ohio to a facility located in Texas and then back to Ohio where the liquid coating containers were reopened and assessed for the degree of skin formation. As seen in previous trials, skinning was most evident in pails located in the top layer of each pallet.

As the bar graph, FIG. 1 effectively demonstrates the essentially non-volatile float materials containing 12% L62 approached the relative effectiveness of the standard 50/50 DEG/water blend (“DEG”).

Being a non-ionic surfactant, L-62 can reduce the efficacy of associative thickeners that may also be present in the coating composition. The table below illustrates this effect for two representative Interior/Exterior tint bases which are available from ICI Paints as shown in Table I at the 6 ounces/five gallon rate of addition.

TABLE 1

| Untinted | Interior Latex | Exterior Latex |
|---|---|---|
| Paints | Semi-Gloss | Semi-Gloss |
| No float | 112 KU | 105 KU |
| 12% L62 float | 105 KU | 99 KU |
| 10% L62 float | 106 KU | 99 KU |
| 8% L62 float | 107 KU | 100 KU |
| 6% L62 float | 108 KU | 101 KU |

The essentially non-volatile non-ionic surfactant Pluronic L62 performed similarly to the 50/50 mixture of Diethylene Glycol and water as shown for other selected performance properties of two representative Low-VOC Interior/Exterior 50 g/l formulas in Table 2 below:

TABLE 2
Effect of Standard Diethylene Glycol Float versus Pluronic L62
Float on Low-VOC Interior/Exterior Water Borne Paints

| | | L62 float | L62 float |
|---|---|---|---|
| No Float | Std. DEG float | (12%) | (6%) |

Low VOC Interior Semi-Gloss Paint

| | | | | |
|---|---|---|---|---|
| Viscosity | 102 KU | 100 | 96 | 98 |
| ICI | 1.3 | 1.4 | 1.3 | 1.3 |
| 60° gloss | 51.7 | 51.6 | 55.9 | 55.3 |
| Leneta sag | 12 | 14 | 14 | 12 |
| Blocking | 2 | 2 | 1.5 | 1.5 |
| Shim scrub | 675 | 840 | 615 | 785 |
| CR (3/3) | 97.61 | 97.53 | 97.71 | 97.47 |
| Tint (DL) | Std. | −0.12 | 0.11 | −0.17 |

Low VOC Exterior Semi-Gloss Paint

| | | | | |
|---|---|---|---|---|
| Viscosity | 104 KU | 102 | 102 | 102 |
| ICI | 1 | 1.1 | 1.1 | 1.1 |
| 60° gloss | 65 | 64.7 | 61.7 | 61.6 |
| Leneta sag | 25 | 25 | 25 | 25 |
| Blocking | 3 | 3 | 3 | 3 |
| Erosion scrub | 1075 | 1110 | 1080 | 1140 |
| Tint (DL) | Std. | −0.80 | −1.10 | −1.77 |

The 6% Pluronic L62 float had only minimal effects on viscosity and other properties as a float material and because of its anti-skinning performance was reasonably close to that of the DEG/Water standard. As such, it was determined that a 6% mixture of Pluronic L-62/Water is well suited as an essentially non-volatile float material.

In order to establish a comparison between diethylene glycol/water float as taught by U.S. Pat. No. 6,354,063 and the results obtained from the evaluation of several of the non-ionic and anionic surfactants evaluated by the present disclosure, tests were also performed using Ethanol, 2,2′-oxybis- as commercially available Diethylene Glycol (DEG) from a variety of commercial chemical manufacturers, as taught by U.S. Pat. No. 6,354,063. Such a comparison is possible because the present disclosure changes neither the water borne coating composition upon which the float material is being applied nor the process which is being utilized to deploy the float onto the surface of that water borne coating composition.

A small scale transportation test was conducted to determine the anti-skinning capability of the essentially non-volatile surfactant in paint containers transported in an automobile trunk. The tests were carried out by placing 31 liquid ounces of a commercially available latex paint into a quart metal paint can followed by slowly pouring 24 grams of the experimental skin-inhibiting aqueous float mixtures onto the surface of the latex paint. After placing the test cans into a cardboard carton, they were placed in an automobile trunk for a period of two weeks while the automobile traveled a distance of about 54 miles/day. After the two week period, the cans were opened and visually assessed for skin formation. The best skin-inhibiting mixture of this series contained a polyoxypropylene-polyoxyethylene copolymer of 2500 Daltons molecular weight, commercially available as Pluronic L-62 from BASF corporation.

Skin formation was measured by rinsing liquid paint away from each lid with water and then carefully scraping and rinsing all dried paint (“skins”) into a tared paper filter funnel which was allowed to dry and then weighed to calculate the weight of paint skins found on each lid. Skin formation was most evident in pails located in the top layer of each pallet.

As the Table 3 shows, the aqueous mixtures containing the polyoxypropylene-polyoxyethylene copolymer of 2500 Daltons molecular weight non-ionic surfactant was an effective aqueous skin inhibiting mixture. A polyoxypropylene-polyoxyethylene copolymer of 2500 Daltons molecular weight is, by virtue of its high molecular weight, essentially nonvolatile. A 12% aqueous solution of this surfactant very closely approached the effectiveness of a 50% diethylene glycol/water blend, a preferred skin inhibiting mixture taught by U.S. Pat. No. 6,354,063. In contrast to the non-ionic and anionic surfactants of this invention, diethylene glycol is a 100% volatile organic compound (VOC).

TABLE 3

| Skin-Inhibitor Composition | Grams of Skins per Lid |
|---|---|
| NONE | 15.60 |
| WATER | 12.40 |
| 6% L62 | 8.97 |
| 12% L62 | 8.00 |
| 50% Diethylene glycol | 7.20 |

Also tested as a float addition to this paint was Polyoxypropylene-polyoxyethylene Block Copolymer (mol. weight 2,650 g/mol, 60% PO, 40% EO as commercially available under the trade name Pluronic 17R4 from BASF Corporation. In general, the Pluronic surfactants are a functionally blocked copolymer with terminal secondary hydroxyl groups which can be described as:

A non-ionic surfactant that is 100% active having:

Cloud point (1% aqueous) . . . (variable)

Water, weight % . . . 0.2 to 0.4 max.

pH (2.5% aqueous) . . . 5.0 to 7.5

Typical Physical Properties

Form . . . Liquid, paste

Average molecular weight . . . 1850 to 4800

Specific gravity, 25° C./25° C. . . . 1.02 to 1.06

Viscosity, cps at 25° C. . . . 180 to 600

Surface tension (0.1% aqueous) . . . 42 to 47 dynes/cm at 25° C.

HLB . . . 1 to 50

Solubility in water at 25° C. . . . >10%

In a separate paint sample another non-ionic surfactant was added, Carbowet DC01 which is commercially available from Air Products. The Carbowet DC01 surfactant is a blend of non-ionic surfactants and can be characterized as a multi-functional, low-foaming, solvent-free and APE (alkyl phenol ethoxylate) free additive for pigment and substrate wetting.

In a separate test, samples of float-only material were prepared in the same manner as described above, and then analyzed by ASTM D 68860-03 to determine whether or not their addition will have a significant effect on the overall VOC-content of a liquid water borne coating composition when the test materials are applied as a float material and subsequently incorporated into the coating composition during final use. The results of these analyses are tabulated in Table 4.

TABLE 4

| | | VOC |
|---|---|---|
| | | (in g/l |
| Float Material | Quantity Detected * | minus water) |
| 6% by weight Dextrol OC-15 | <0.02%, by weight | <0.4 |
| 6% by weight Pluronic 17R4 | <0.02%, by weight | <0.4 |
| 12% by weight Pluronic L62 | <0.02%, by weight | <0.2 |
| 12% by weight Pluronic 17R4 | <0.02%, by weight | <0.2 |

* ASTM Method D 6886-03 Method Detection Limit

In another test, a comparison was made between the VOC-content of different water borne coating compositions with a variety of float materials being added. Tests were performed using a Lifemaster Latex Interior Eggshell and a Dulux Ultra Velvet Interior Soft Sheen, both liquid coating compositions which are commercially available from ICI Paints. The range of float materials being added during this test ranged from the low of no float being added to aqueous solutions containing 6% by weight of three (3) different float materials, to a high of an aqueous solution containing 50% by weight of diethylene glycol. The liquid coating compositions were then mixed in a manner consistent with the level of mixing that one would expect when a colorant or tinter has been added to the coating composition, and then the coating compositions were sampled and analyzed for VOC-content. Table 5 indicates the configurations of coating composition and float materials that were subjected to testing in this manner.

TABLE 5

| Water Borne Coating Description | Sample I.D. | Description |
|---|---|---|
| Lifemaster Interior Latex | 1A | No float |
| Eggshell Coating | | |
| Lifemaster Interior Latex | 1B | 50% DEG float |
| Eggshell Coating | | |
| Lifemaster Interior Latex | 1C | 6% Pluronic L62 |
| Eggshell Coating | | |
| Lifemaster Interior Latex | 1D | 6% Dextrol OC-15 |
| Eggshell Coating | | |
| Lifemaster Interior Latex | 1E | 6% Pluronic 17R4 |
| Eggshell Coating | | |
| Dulux Ultra Velvet Latex | 2A | No float |
| Soft Sheen Coating | | |
| Dulux Ultra Velvet Latex | 2B | 50% DEG float |
| Soft Sheen Coating | | |
| Dulux Ultra Velvet Latex | 2C | 6% Pluronic L62 |
| Soft Sheen Coating | | |
| Dulux Ultra Velvet Latex | 2D | 6% Dextrol OC-15 |
| Soft Sheen Coating | | |
| Dulux Ultra Velvet Latex | 2E | 6% Pluronic 17R4 |
| Soft Sheen Coating | | |

Table 6 tabulates the weight percent of the individual volatile organic species that were found within samples obtained from these test materials when analyzed according to ASTM Method D-6886-03 using a Hewlett-Packard (Agilent) 6890 gas chromatograph using a flame-ionization detector. The chromatographic column used for these analyses was a DB-225 (50% cyanopropylphenyl)methylpolysiloxane capillary column. The method detection limit for this analysis is approximately 0.002%, by weight.

TABLE 6

| Lifemaster Interior Latex | 1A | 1B | 1C | 1D | 1E | |
|---|---|---|---|---|---|---|
| Eggshell Coating | | | | | | |
| n-butyl ether | 0.014 | 0.014 | 0.014 | 0.014 | 0.014 | % |
| Unknown | 0.052 | 0.050 | 0.054 | 0.057 | 0.058 | % |
| diethylene glycol | N.D. | 0.412 | N.D. | N.D. | N.D. | % |
| Total VOCs | 0.066 | 0.476 | 0.068 | 0.071 | 0.072 | % |
| Dulux Ultra Velvet Interior | 2A | 2B | 2C | 2D | 2E | |
| Latex Soft Sheen Coating | | | | | | |
| n-butyl ether | 0.004 | 0.004 | 0.004 | 0.004 | 0.004 | % |
| ethylene glycol | 0.834 | 0.811 | 0.782 | 0.826 | 0.820 | % |
| diethylene glycol | N.D. | 0.478 | N.D. | N.D. | N.D. | % |
| butyl carbitol | 0.324 | 0.316 | 0.308 | 0.318 | 0.313 | % |
| Texanol | 2.02 | 2.06 | 2.10 | 2.16 | 2.14 | % |
| Total VOCs | 3.182 | 3.669 | 3.194 | 3.308 | 3.277 | % |

N.D. indicates none detected.

The weight per gallon and % TNV (percent total non-volatiles) were also determined on each of the relevant materials. Using this information, it was possible to convert the data on weight percent total VOCs to determine its relative VOC-content in terms of grams/liter and grams/liter minus water.

Table 7 depicts this information, as well as the VOC-content of the test materials when calculated in a manner similar to that being used to ascertain regulatory compliance in various regions of the country. As has been determined, the VOC-content of the various liquid coating compositions where experimental float materials have been added (as described in Table 5) are not significantly different in value to that which was obtained from liquid coating compositions where no experimental float materials had been added. A review of this same data also indicates that the VOC-content of all of the liquid coatings compositions where experimental float materials have been added are significantly lower that the results which were obtained on those same liquid coating compositions where the standard 50/50 DEG/water float material had been added.

TABLE 7

| Lifemaster | 1A | 1B | 1C | 1D | 1E | |
|---|---|---|---|---|---|---|
| Interior Latex | | | | | | |
| Eggshell | | | | | | |
| Coating | | | | | | |
| Total VOCs | 0.066 | 0.476 | 0.068 | 0.071 | 0.072 | % |
| Total | 55.91 | 55.50 | 55.50 | 55.49 | 55.59 | % |
| Non-Volatiles | | | | | | |
| Weight/gallon | 11.339 | 11.320 | 11.310 | 11.301 | 11.312 | lbs/gal |
| Density in g/cc | 1.36 | 1.36 | 1.36 | 1.35 | 1.36 | |
| VOC (g/l | 0.90 | 6.46 | 0.92 | 0.96 | 0.98 | |
| in product) | | | | | | |
| VOC (g/l | 2.24 | 16.10 | 2.33 | 2.43 | 2.46 | |
| minus water) | | | | | | |
| VOC (lbs/gal | 0.02 | 0.13 | 0.02 | 0.02 | 0.02 | |
| minus water) | | | | | | |
| Dulux Ultra | 2A | 2B | 2C | 2D | 2E | |
| Velvet Latex | | | | | | |
| Soft Sheen | | | | | | |
| Coating | | | | | | |
| Total VOCs | 3.182 | 3.669 | 3.194 | 3.308 | 3.277 | % |
| Total | 58.08 | 57.96 | 59.04 | 57.97 | 58.13 | % |
| Non-Volatiles | | | | | | |
| Weight/gallon | 12.202 | 12.242 | 12.303 | 12.224 | 12.238 | lbs/gal |
| Density in g/cc | 1.46 | 1.47 | 1.47 | 1.46 | 1.47 | |
| VOC (g/l | 46.5 | 53.8 | 47.1 | 48.5 | 48.1 | |
| in product) | | | | | | |
| VOC (g/l | 107.7 | 123.6 | 106.6 | 112.4 | 111.2 | |
| minus water) | | | | | | |
| VOC (lbs/gal | 0.90 | 1.03 | 0.89 | 0.94 | 0.93 | |
| minus water) | | | | | | |

What is claimed is:

1) An article or a container containing a water borne coating composition, comprising:
a container having an opening at one end which is covered with a lid;
a water borne coating composition occupying the lower inside portion of the container; and
a float material comprised of water and at least one non-ionic or anionic surfactant having oxyalkylene moieties present in the mixture in an amount up to 60 weight percent of the mixture, wherein the mixture is present in an amount effective to provide up to about an inch thick liquid film in contact with the exposed surface of water borne coating composition in the container, and
a head space above the upper portion of the float to at least allow for the closing of the lid to cover the opening of the container.

2) The article of claim 1, wherein the surfactant is selected from at least one of the poly (oxyethyleneoxypropylene) copolymers having an amount of POE from 5 to 50 weight percent of the copolymer and a molecular weight of less than 5,000 grams/mole.

3) The article of claim 1, wherein the surfactant is selected from at least one of copolymer with oxyalkylene moieties that is polyoxypropylene—polyoxyethylene block copolymer having a molecular weight of up 2500 Daltons, and has 20% polyoxyethylene and a specific gravity of about 1.03.

4) The article of claim 1, wherein the surfactant is a copolymer having the formula:
RO—(CH₂—CH₂—O—)ₙ—(CH₂.(CH₃)—CH—O—)ₘH,
wherein R is H or C1 to C4 alkyl groups; and n and m are positive integers sufficient to add up to a molecular weight of the copolymer in the range up to less than 5,000 grams/mole.

5) The article of claim 2, wherein the molecular weight of the hydrophobe is greater than 1200 grams/more

6) The article of claim 1, wherein the thickness of the float film is less than about 0.25 inches.

7) The article of claim 2, wherein the thickness of the float film is less than about 0.25 inches.

8) The article of claim 1, wherein the water borne coating composition is comprised of at least one or more latex film forming polymers.

9) The article of claim 1, wherein the water borne coating composition is a paint, a stain or a varnish.

10) The article of claim 1, wherein the float material is mixed into the water borne coating composition.

11) The article of claim 1, wherein at least one colorant or tinter comprising at least one pigment is added to the water borne coating composition and upon mixing of the colorant or tinter with the water borne coating composition, the float material is incorporated into the coating composition.

12) The article of claim 1, wherein the headspace of air is or sufficient volume to allow for the addition to the container of at least one colorant or tinter comprising at least one pigment.

13) The article of claim 1, wherein the exposed surface of the coating composition is that not contacting the container.

14) The article of claim 1, wherein the thickness of the float material contacting the surface of the coating composition is in the range from 0.03 to 0.25 inch.

15) A method to decrease formation of non-water dispersible films with water borne coating compositions, comprising:
adding at least one essentially non-volatile coating-compatible aqueous mixture comprised of water and a chemical additive during the packaging of water borne coatings as a float on the surface of the liquid coating composition while in the container thereby minimizing the formation of water insoluble films on the non-submerged interior surfaces of the container and lid that are used to transport and store the waterborne coating composition.

16) The method of claim 15, wherein the chemical additive is selected from at least one of the poly (oxyethyleneoxypropylene) copolymers having an amount of POE from 5 to 50 weight percent of the copolymer and a molecular weight of less than 5,000 grams/mole.

17) The method of claim 15, wherein the chemical additive is an aqueous mixture of up to 50 weight percent of polyoxypropylene—polyoxyethylene block copolymer having a molecular weight of 2500 Daltons, 20% polyoxyethylene and a specific gravity of about 1.03.

18) The method of claim 15, wherein the water is deionized water.
